(19) United States
(12) Patent Application Publication
(10) Pub. No.: US 2005/0180523 A1
(43) Pub. Date: Aug. 18, 2005

(54) Wireless digital signal transmission method

(76) Inventors: Jianping Gao, Shanghai (CN); Yu Cao, Shanghai (CN); Xiaoqing Jin, Shanghai (CN)

Correspondence Address: RAYMOND Y. CHAN, 108 N. YNEZ AVE., SUITE 128, MONTEREY PARK, CA, 91754, US

(21) Appl. No.: 10/970,055

(22) Filed: Oct. 19, 2004

(30) Foreign Application Priority Data
Feb. 18, 2004 (CN) 200410016397X

(51) Int. Cl. H04B 7/14

(52) U.S. Cl. 375/295

(57) ABSTRACT

A method of wirelessly transmitting digital signal includes the steps of (a) dividing a digital signal into a primary signal band and a secondary signal band; (b) phrase-shifting the secondary signal to form a reverse signal with respect to the primary signal band in such a manner that the reverse signal is one hundred and eighty degrees out of phrase with the primary signal band; (c) encoding the primary signal band and the reverse signal; (d) wirelessly transmitting the primary signal band and the reverse signal; (e) decoding the encoded primary signal band and the encoded reverse signal; and (f) combining the primary signal band and the reverse signal to re-form the digital signal.

### BACKGROUND OF THE PRESENT INVENTION

1. Field of Invention

The present invention relates to wireless communication, and more particularly to a method of wirelessly transmitting digital signals, which has enhanced resistance against unwanted interference so as to achieve better quality wireless data transmission.

2. Description of Related Arts

Wireless data transmission has long been utilized in a wide variety of practical applications. For example, in a conventional karaoke system, wireless microphone has been utilized for wirelessly transmitting audio signals from the singer to the speakers, so as to eliminate the deep-seated problem of severe wire tangling in a confined karaoke room.

During a typical wireless audio transmission, a particular set of sound signals would first be converted into binary form (i.e. either 0 or 1) before it is transmitted through a predetermined channel. Conventionally, the audio data in its binary form may be represented by one of the several physical parameters, such as amplitude, wavelength, and frequency. Discrete data in binary form which is transmitted wirelessly would then be demodulated and processed to form a compete set of audio signal which should be substantially identical with the original audio signal.

A major problem for this conventional wireless transmission system and method thereof is that the data transmitted is subject to severe interference. For instances, for those signals represented by amplitude, the two discrete amplitudes respectively representing the two binary digits must be clearly identified so as to achieve an accurate data transmission. Otherwise, the audio signals transmitted would be distorted or, in the worse case, altogether lost.

As a matter of fact, the representation of the audio signal by different frequencies could reduce the extent to which the audio signal is interfered by external noise. However, a major problem for this form of data transmission is that each bit of digital information must be represented by a plurality of impulses at a particular predetermined frequency. As such, this transmission method involves substantial computing resources and therefore cost-inefficient.

As more and more conventional equipments have been digitized for achieving better performance and lower operation costs, the demand for digital wireless transmission is expected to rise in a remarkable speed. Furthermore, with the advance of information technology, the information which needs being wirelessly transmitting is becoming more and more sophisticated. Therefore, accurate and rapid wireless data transmission is inevitably required.

### SUMMARY OF THE PRESENT INVENTION

A main object of the present invention is to provide a method of wirelessly transmitting digital signal, such as audio signal, which is adapted to resist unwanted interference while at the same time achieving efficient computing resources usage.

Another object of the present invention is to provide a method of wirelessly transmitting digital signal, wherein the transmission method comprises a step of encoding the digital signal transmitted so as to prevent unauthorized access to the digital data. In other words, the present invention enhances wireless transmission security of digital data.

Another object of the present invention is to provide a method of wirelessly transmitting digital signal which does not involve complicated electronic circuits to process the digital signal such that the manufacturing and the running cost of the present invention can be minimized.

Accordingly in order to achieve the above objects, the present invention provides a method for transmitting digital signal, comprising the steps of:
(a) dividing a digital signal into a primary signal band and a secondary signal band;
(b) phrase-shifting the secondary signal band to form a reverse signal with respect to the primary signal band in such a manner that the reverse signal is one hundred and eighty degrees out of phrase with the primary signal band;
(c) encoding the primary signal band and the reverse signal;
(d) wirelessly transmitting the primary signal band and the reverse signal;
(e) decoding the primary signal band and the reverse signal; and
(f) combining the primary signal band and the reverse signal to re-form the digital signal.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram illustrating a method of wirelessly transmitting digital signal according to a preferred embodiment of the present invention.

FIG. 2 is a circuit diagram of a signal transmitter for use in the method of wirelessly transmitting digital signal according to the above preferred embodiment of the present invention.

FIG. 3 is a circuit diagram of a signal receiver for use in the method of wirelessly transmitting digital signal according to the above preferred embodiment of the present invention.

### DETAILED DESCRIPTION OF THE PREFERRED EMBODIMENT

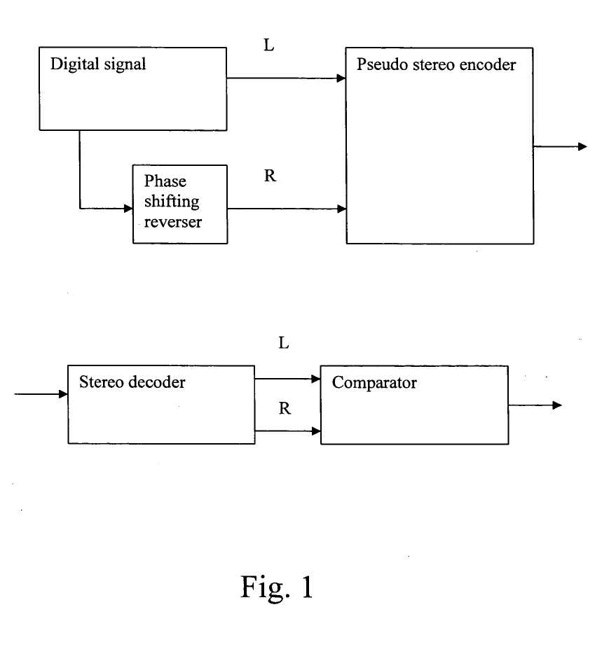

Referring to FIG. 1 of the drawings, a method of wirelessly transmitting digital signal, such as a digital audio signal generated by a wireless microphone, according to a preferred embodiment of the present invention is illustrated, wherein the transmission method comprises the steps of:
(a) dividing a digital signal into a primary signal band and a secondary signal band;
(b) phrase-shifting the secondary signal to form a reverse signal with respect to the primary signal band in such a manner that the reverse signal is one hundred and eighty degrees out of phrase with the primary signal band;
(c) encoding the primary signal band and the reverse signal;
(d) wirelessly transmitting the encoded primary signal band and the encoded reverse signal;
(e) decoding the encoded primary signal band and the encoded reverse signal; and
(f) combining the primary signal band and the reverse signal to re-form the digital signal.

In step (a) above, the primary signal band and the secondary signal band are adapted for being outputted at left and right audio channel respectively so as to form stereo audio effect from the digital signal.

In the step (c) above, the primary signal band and the reverse signal are fed into a signal encoder, such as a pseudo-stereo encoder, which is adapted to encode the primary signal band and the reverse signal into a predetermined set of data (such as a predetermined set of pseudo-stereophonic signal), in such a manner that such encoded primary signal band and the reverse signal can only be decoded by particular decoder so as to prevent interference or unauthorized access to the reverse signal.

Accordingly, in step (e) above, the encoded primary signal band and the encoded reverse signal are fed into a signal decoder which is adapted to decode the encoded primary signal band and the encoded reverse signal so as to restore them into the original primary signal band and the reverse signal as mentioned in the step (a) and the step (b).

The above step (f) further comprises the steps of:
(f.1) comparing the primary signal band with the reverse signal, wherein when the primary signal band is greater than the reverse signal, a high level digital signal is formed, and wherein when the primary signal band is smaller than the reverse signal, a low level digital signal is formed; and
(f.2) outputting the digital signal in accordance with a result of the step (f1).

It is worth mentioning that in the step (f.1) above, the comparing step should be accomplished by a signal comparator which is adapted to output two discrete levels of electrical signal which is corresponding to the result of the relevant comparisons.

In step (d) above, the encoded primary signal band and the encoded reverse signal are wirelessly transmitted at a signal transmitter and accordingly, the transmission method further comprises a step (d.1) after step (d) of receiving the encoded primary signal band and the encoded reverse signal at a signal receiver. Note that the signal decoder, the signal comparator, as well as the signal transmitter are preferably embodied as electrically connecting with each other so as to form a single unit.

Furthermore, in order to simultaneously transmit both the encoded primary signal band and the encoded reverse signal in an efficient manner, the step (d) comprises a sub-step of superimposing a pilot frequency to the encoded primary signal band and the encoded reverse signal before transmitting thereof such that a single transmission channel can be utilized to transfer both the encoded primary signal band and the encoded reverse signal. The pilot frequency superimposed on the encoded primary signal band and the encoded reverse signal is preferably embodied as half of the transmission frequency, i.e. 19 KHz.

According to the preferred embodiment of the present invention, in the step (c) above, the primary signal band and the reverse signal are encoded by a pseudo-stereo encoder which then generates the encoded pseudo-stereophonic signal corresponding with the primary signal band and the reverse signal. During the pseudo stereophonic encoding process, the pseudo-stereophonic signal is outputted with a 38 KHz frequency.

In the step (f.1) above, the high level digital signal and the low level digital signal represent, respectively, two discrete energy levels of the digital signal in its binary form. According to the preferred embodiment, the two discrete energy levels represent “0” and “1” in traditional binary format respectively.

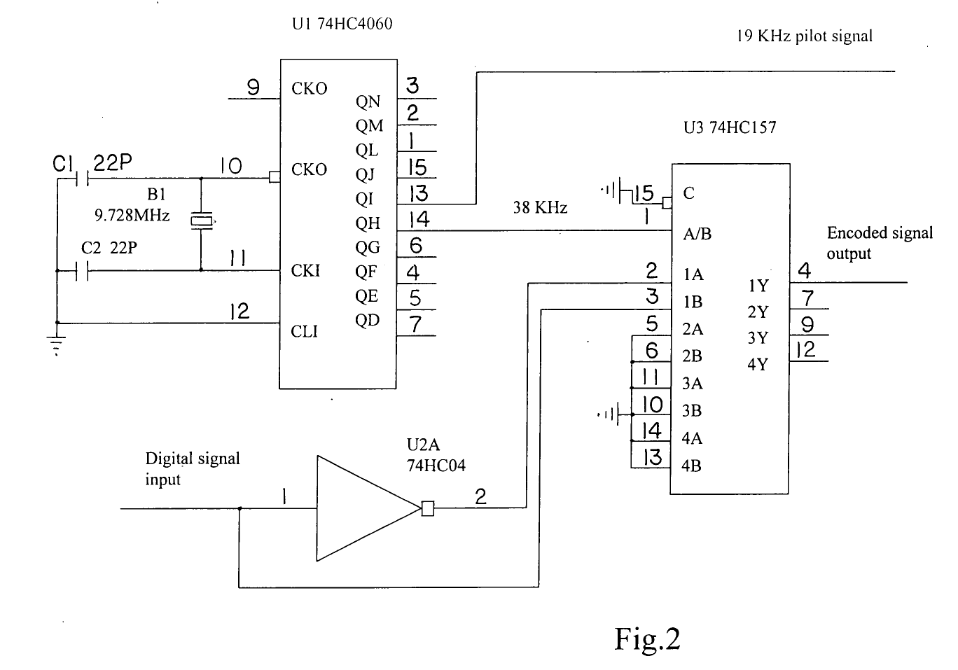

Referring to FIG. 2 of the drawings, an electric circuit diagram of the signal transmitter is illustrated, wherein the integrated circuit U1, U2, and U3 belong to 74HC series circuits.

As shown in FIG. 2, U1(74HC4060) is an oscillating frequency-dividing circuitry having pin 1 through pin 15. Pin 10 and Pin 11 are adapted to electrically connect with external quartz crystal, pin 9 is embodied as oscillating signal output, while pin 12 is embodied as a clearance control output. Pin 1 to pin 7 and pin 13 to pin 15 are respectively different frequency outputs which are adapted to output signals with different frequencies differentiated by the oscillating frequency-dividing circuitry U1.

U2 (74HC04) is a reverse circuitry which is adapted to introduce 180 degrees phrase shift to inputted signal.

U3 (74HC157) is a selection circuitry adapted to provide four different utility circuits for selection. As an illustration, the utility circuit as shown in FIG. 2 of the drawings has three terminals, namely pin 2, pin 3, and pin 4. Pin 2 and pin 3 are signal input, while pin 4 is signal output. Pin 1 is selection input through which selection signal can be inputted for switching from one utility circuit to another. Pin 13 is a saving output by which electric signal which is to be saved is outputted.

According to the preferred embodiment of the present invention, the integrated circuit U1 combines with the oscillator B1, the capacitor C1 and the capacitor C2 to form a 9.728 MHz oscillator. The integrated circuit U1 is adapted to perform frequency division and a switching signal of 38 kHz is outputted via pin 14 after eight subsequent frequency division. At the mean time, the pilot signal (necessary for wireless transmission) which is of 19 KHz frequency is obtained at the pin 13. U3 is a digital selection circuitry wherein pin 1 is arranged to be fed with the 38 KHz switching signal outputted from U1. Moreover, pin 2 and pin 3 are adapted for respectively inputting the primary signal band from U1 and the reverse signal signals from U2.

The primary signal band and the reverse signal are encoded at U3 to form the pseudo-stereophonic signal which is of 38 KHz frequency. The pseudo-stereophonic signal will be outputted at pin 4 of U3 and, according to the step (d), the pseudo-stereophonic signal will be superimposed with a 19 KHz pilot signal for wirelessly transmitting to the signal receiver.

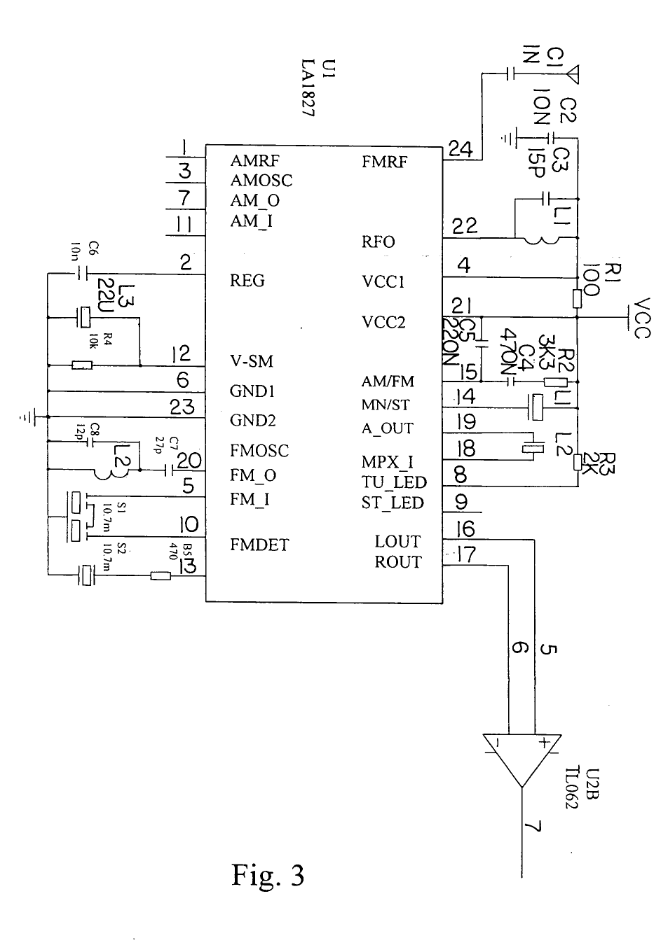

Referring to the FIG. 3 of the drawings, the electrical circuit for the signal receiver is illustrated, wherein the primary signal and the reverse signal which are wireless transmitted are received by the signal receiver. The integrated circuit U1 (LA1827) is a frequency-modulation/amplitude-modulation (FM/AM) receiving circuitry, wherein a plurality of FM receiver modules, FM demodulation modules, and stereo decoder modules are integrated thereof.

As shown in FIG. 3 of the drawings, the various functions of the pins of the U1(LA1827) integrated circuit are elaborated in table 1 below:

| PIN number | Function |
|---|---|
| 1, 3, 7, 11 | AM receiving terminals |
| 2 | Signal filtering |
| 4, 21 | Power terminals |
| 5 | AM signal output |
| 6, 23 | Ground |
| 8 | Modulation command output |
| 9 | Stereo parameters output |
| 10 | Mid-range frequency AM signal input |
| 12 | FM signal intensity output |
| 13 | FM signal discrimination input |
| 14 | Frequency-discrimination filtering |
| 15 | Phase comparison filtering |
| 16 | Left channel audio output |
| 17 | Right channel audio output |
| 18 | stereo decoder modules input |
| 19 | FM signal discrimination output |
| 20 | Oscillation FM signal input |
| 22 | Mixed FM output |
| 24 | Antenna input |

It is worth mentioning that pin 1, pin 3, pin 7, and pin 11 which are shown in FIG. 3 of the drawings are adapted for receiving AM signal, yet which are not utilized according to the preferred embodiment of the present invention.

The integrated circuit U2 (TL062) is an operational amplifier used in the present invention as the signal comparator.

The encoded pseudo-stereophonic signal received by the antenna will be directed to the pin 24 through a capacitor C1 and subsequently to be received via LA1827. After a FM demodulation process, a mixed stereo signal is outputted from pin 19 of the LA1827, while the mixed stereo signal will be directed into pin 18 of the internal stereo decoder module so that the mixed stereo signal will be decoded back to the primary signal band and the reverse signal and respectively being outputted from pin 16 and pin 17. Finally, the primary signal band and the reverse signal are directed into U2 (TL062) for comparison in a manner described in step (f).

From the forgoing descriptions, it can be seen that the above-mentioned objects have been substantially achieved. The present invention provides an efficient and an effective method of digital signal transmission while maintaining the highest standard of transmission quality and security. External interference to the signal transmission is minimized.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

1. A method of wirelessly transmitting digital signal, comprising the steps of:
(a) dividing said digital signal into a primary signal band and a secondary signal band;
(b) phrase-shifting said secondary signal band to form a reverse signal with respect to said primary signal band in such a manner that said reverse signal is one hundred and eighty degrees out of phrase with said primary signal band;
(c) encoding said primary signal band and said reverse signal;
(d) wirelessly transmitting said primary signal band and said reverse signal;
(e) decoding said encoded primary signal band and said encoded reverse signal; and
(f) combining said decoded primary signal band and said decoded reverse signal to re-form said digital signal.

2. The method as recited in claim 1, in step (f), further comprising the steps of:
(f.1) comparing said primary signal band with said reverse signal, wherein when said primary signal band is greater than said reverse signal, a high level digital signal is generated, and when said primary signal band is smaller than said reverse signal, a low level digital signal is created; and
(f.2) outputting said digital signal in accordance with a result of said comparison step.

3. The method as recited in claim 1, in step (d), further comprising a sub-step of superimposing a pilot frequency to said encoded primary signal band and said encoded reverse signal before wirelessly transmitting thereof.

4. The method, as recited in claim 2, in step (d), further comprising a sub-step of superimposing a pilot frequency to said encoded primary signal band and said encoded reverse signal before wirelessly transmitting thereof.

5. The method as recited in claim 1, after said step (d), further comprising a step of receiving said encoded primary signal band and said encoded reverse signal at a signal receiver.

6. The method as recited in claim 3, after said step (d), further comprising step of receiving said encoded primary signal band and said encoded reverse signal at a signal receiver.

7. The method as recited in claim 4, after said step (d), further comprising a step of receiving said encoded primary signal band and said encoded reverse signal at a signal receiver.

8. The method, as recited in claim 6, wherein said pilot frequency is approximately 19 KHz.

9. The method, as recited in claim 7, wherein said pilot frequency is approximately 19 KHz.

10. The method as recited in claim 1, in step (c), wherein said primary signal band and said reverse signal are encoded by a pseudo-stereo encoder which is adapted to generate encoded pseudo-stereophonic signal corresponding with said primary signal band and said reverse signal having a frequency of approximately 38 KHz.

11. The method as recited in claim 7, in step (c), wherein said primary signal band and said reverse signal are encoded by a pseudo-stereo encoder which is adapted to generate encoded pseudo-stereophonic signal corresponding with said primary signal band and said reverse signal having a frequency of approximately 38 KHz.

12. The method, as recited in claim 8, in step (c), wherein said primary signal band and said reverse signal are encoded by a pseudo-stereo encoder which is adapted to generate encoded pseudo-stereophonic signal corresponding with said primary signal band and said reverse signal having a frequency of approximately 38 KHz.

13. The method as recited in claim 9, in step (c), wherein said primary signal band and said reverse signal are encoded by a pseudo-stereo encoder which is adapted to generate encoded pseudo-stereophonic signal corresponding with said primary signal band and said reverse signal having a frequency of approximately 38 KHz.

14. The method as recited in claim 2, in step (f.1), wherein said high level digital signal and said low level digital signal represent, respectively, two discrete energy levels of said digital signal in a binary form.

15. The method as recited in claim 9, in step (f.1), wherein said high level digital signal and said low level digital signal represent, respectively, two discrete energy levels of said digital signal in a binary form.

16. The method as recited in claim 13, in step (f.1), wherein said high level digital signal and said low level digital signal represent, respectively, two discrete energy levels of said digital signal in a binary form.

17. The method as recited in claim 2, in step (f.1), wherein said comparison is performed by a signal comparator which is adapted to output two discrete levels of electrical signal which are corresponding to said high level digital signal and said low level digital signal respectively.

18. The method as recited in claim 14, in step (f.1), wherein said comparison is performed by a signal comparator which is adapted to output two discrete levels of electrical signal which are corresponding to said high level digital signal and said low level digital signal respectively.

19. The method as recited in claim 15, in step (f.1), wherein said comparison is performed by a signal comparator which is adapted to output two discrete levels of electrical signal which are corresponding to said high level digital signal and said low level digital signal respectively.

20. The method as recited in claim 16, in step (f.1), wherein said comparison is performed by a signal comparator which is adapted to output two discrete levels of electrical signal which are corresponding to said high level digital signal and said low level digital signal respectively.
